(19) United States
(12) Patent Application Publication
(10) Pub. No.: US 2016/0131270 A1
(43) Pub. Date: May 12, 2016

(54) Valve

(71) Applicant: FESTO AG & CO. KG, Esslingen (DE)

(72) Inventors: Michael Berner, Kirchheim (DE); Falk Rapke, Tubingen (DE)

(21) Appl. No.: 14/898,891

(22) PCT Filed: Jul. 5, 2013
(86) PCT No.: PCT/EP2013/001977

§ 371 Date: Dec. 16, 2015

(51) Int. Cl. F16K 11/07

(52) U.S. Cl. CPC F16K 11/0712

(57) ABSTRACT

A valve includes at least one seal ring arranged in a recess of a valve housing, which seal ring has a seal housing having a U-shaped cross-section, in which an annular sealing element is arranged. At least one of the two housing legs of the seal housing is designed as a guiding leg, which effects transverse support and linear displacement guidance of a valve slide that passes through the seal ring.

The invention relates to a valve comprising a valve housing and a piston-type valve spool arranged in an axially displaceable manner in a recess of the valve housing while performing linear switching movements between various working positions, the recess having a central longitudinal axis, and further comprising at least one seal ring which coaxially encloses the valve spool in the recess and which has an annular seal housing located stationary relative to the valve housing and having a U-shaped cross-section with two opposite housing legs, the seal housing bounding a reception chamber which has, radially on the inside, a slot-like housing opening laterally flanked by the two housing legs and in which an annular sealing element designed on the one hand for acting together with the inner surface of the seal housing to form a static seal and on the other hand for acting together with the outer circumferential surface of the valve spool to form a dynamic seal is coaxially arranged, the sealing element having, for dynamic sealing, a dynamic sealing section located in the region of the housing opening and coaxially enclosing the valve spool with sealing contact in at least one of its working positions.

A valve of this type, which is known from EP 0 475 070 A1, is provided with a plurality of seal rings which are arranged coaxially and consecutively and which have a seal housing with a U-shaped cross-section, being located in a recess of a valve housing by means of this seal housing. Each seal housing bounds a reception chamber in which a sealing element made of an elastomer material is accommodated: this sealing element on the one hand bears against the inner surface of the seal housing while forming a static seal and on the other hand projects with a dynamic sealing section through a radially inward slot-like housing opening of the seal housing to form a dynamic seal against the piston-type valve spool. The dynamic sealing action results from the fact that the valve spool slides along the dynamic sealing sections when switching between its working positions. In this process the sealing elements of the seal rings perform, in addition to their sealing action, a guide action relative to the valve spool by supporting it in the transverse direction and guiding it in its switching movement. This arrangement has the disadvantage that the valve spool can only be displaced by applying a relatively high driving force, which adversely affects the switching speed. In addition, there is the problem that a lubricant which may be applied to the outer circumferential surface of the valve spool is rubbed off by the tight contact of the sealing elements, so that, in particular after a prolonged stoppage, the valve spool tends to adhere to the sealing elements, which can only be counteracted by high driving forces and correspondingly high energy consumption.

Comparable problems have been observed in the valves disclosed in DE 196 03 719 A1 and EP 0 472 910 A1.

From EP 1 847 736 B1, a seal arrangement is known in which a seal ring forming a seal between two machine elements is floating in a mounting groove of the one machine element, the seal ring comprising a static sealing part developing a static sealing action in the mounting groove and, in addition, a second sealing part forming a dynamic seal against the other machine element. In axial section, the seal ring is substantially T-shaped.

The invention is based on the problem of creating a valve with a valve spool which is easily displaceable while providing a good dynamic seal.

In combination with the features listed above, this problem is solved by providing that at least one of the housing legs of the seal housing is designed as a guide leg which has at least one radially inward-facing guide surface which, by direct contact with the outer circumferential surface of the valve spool, provides a transverse support and a linear guidance of the valve spool which is independent of the associated sealing element.

In this way, the functions of dynamic sealing and linear guidance of the valve spool are uncoupled from one another and distributed among different components of the at least one seal ring. Responsible for the sealing action is still a seal ring which is located in a reception chamber of the seal housing and can enclose the valve spool with a dynamic sealing section to form a seal, the valve spool being axially displaceable relative to the dynamic sealing section for moving it into the respective desired working position.

Independently of the sealing element, the valve spool receives transverse support and linear guidance by at least one of the rigid housing legs of the seal housing, which leg is described as guide leg in view of its function. This guide leg has at least one radially inward-facing guide surface which supports the valve spool at right angles to the direction of its switching movement and stabilises its orientation relative to the valve housing. As the guidance function is now taken over by the seal housing, the preload with which the sealing element encloses the valve spool can be reduced to a low value which ensures the desired sealing quality while facilitating an easy movement of the valve spool. In this way, high switching speeds or short switching times can be achieved with the valve, and the problems of wearing away a lubricant film or of a sticking of the valve spool are reduced considerably.

Advantageous further developments of the invention can be derived from the dependent claims.

Although both housing legs of the seal housing can be designed as guide legs in principle, it is considered to be advantageous if only one of the two housing legs is implemented as a guide leg. In this case, the cross-section framed by the housing leg not designed as a guide leg can be greater than the cross-section framed by the guide surface of the guide leg. This measure restricts the guide region to a small axial region of the valve spool, so that side tilt, for example, can be eliminated.

It is further advantageous if the guide surface is not a continuous, closed annular surface, but rather composed of a plurality of guide surface sections distributed at a mutual distance around the valve spool. As a result, the valve spool can be supported locally at several points distributed along its outer circumference. This results in a smaller contact area between the seal housing and the valve spool, promising sliding friction combined with good transverse support.

The guide surface sections are expediently formed on guide projections which project radially inwards relative to adjacent regions of the guide leg. We could, for example, speak of guide segments in this context. These guide projections are designed to be tab-like in particular. The guide surface sections are preferably distributed evenly around the valve spool, irrespective of their design.

The sealing element is preferably designed such and arranged in the seal housing in such a way that at least its dynamic sealing section and preferably the sealing element as a whole is/are capable of floating movement relative to the seal housing in a radial plane extending at right angles to the longitudinal axis of the seal ring. This compensates for manufacturing and assembly tolerances without adversely increasing the surface pressure between the sealing element and the valve spool.

To enable the valve spool to slide easily, the cross-section enclosed by the guide surface is expediently slightly larger than the cross-section of the valve spool, resulting in a minimum running gap between the two components, which is in the range of tenths of a millimetre in particular. As a rule, the valve spool will never be in contact with the whole surrounding guide surface, but only with one or more sub-regions of the guide surface. In view of the radial resilience of the sealing element, however, an unlimited sealing contact is always ensured between the sealing element and the valve spool, even if the position of the latter changes to a minimal degree at right angles to the longitudinal axis of the seal ring owing to the running gap.

In order to support the radial resilience of the annular sealing element, it is advantageous if, between the radially outward-oriented outer circumferential surface of the sealing element and the radially inward-oriented inner circumferential surface of the seal housing, a free annular gap is formed, the gap height of which is expediently chosen such that the sealing element can dip completely into the reception chamber without coming into contact with the radially inward-oriented inner circumferential surface of the seal housing.

In the recess of the valve housing, a plurality of seal rings enclosing the valve spool are expediently arranged at an axial distance from one another. Preferably, all seal rings are secured independently of one another to the valve housing in an axially immovable arrangement. A particularly advantageous solution is considered to be a pressing-in arrangement, in which each seal ring with its seal housing is pressed into the recess of the valve housing and secured therein with press-fit.

It is advantageous if measures are taken to secure the sealing element against being radially pulled out of the reception chamber of the seal housing, in particular against pullout forces based on differential fluid pressure or suction applied to the sealing element. These measures comprise at least one securing projection which projects axially from the sealing element and engages with an axial securing recess formed on the inner surface of the seal housing, resulting in a positive fit in the radial direction.

It is considered to be particularly expedient if the sealing element is provided with a securing projection on each of its two axially opposite side surfaces, the seal housing then having an axial securing recess with which the associated securing projection engages on each of the facing inner surfaces of its housing legs. In all embodiments, it is advantageous if each securing projection and each securing recess is annular and arranged to be concentric with the longitudinal axis of the seal ring.

In a preferred variant of the valve, the seal housing of preferably all of the seal rings is constructed in several parts and has a radially outward-lying annular base section located between the two housing legs, at least one of the two housing legs being designed as a body which is separate from the base section and secured thereto in a joint region. It is considered to be particularly advantageous if each housing leg is separate from the annular base section and secured thereto in its own joint region.

In the interior of the reception chamber of the seal housing, a sealing groove which is open towards the radial inside and designed as an annular groove and into which the sealing element dips with its radially outward static sealing section is formed in the radially inward-oriented inner circumferential surface of the base section, this static sealing section being designed to act together axially with the two groove sides of the sealing groove located opposite each other in the base section to provide a static seal.

This facilitates a cost-effective multi-part construction of the seal housing, because there is no need for a hermetic seal for the respective joint region. The sealing element acts as a fluid-tight blocking element, because it bears against the valve spool with its dynamic sealing section on the one hand and against at least one groove side of the sealing groove with its static sealing section on the other hand, so that a fluid entering the reception chamber through a joint region cannot reach the opposite side of the sealing element. It is, of course, nevertheless possible for the joint region to be sealed. However, there is no need for expensive tightness checks, because any leak which might occur does not affect the desired functionality of the valve.

On the axially opposite side surfaces of its static sealing section, the seal ring is preferably provided with a raised sealing region which is, for example, designed as an annular sealing edge or an annular sealing bead and which can bear against the groove side of the sealing groove with a high axial surface pressure, resulting in a seal of high quality.

It is considered to be particularly expedient if the static sealing section is designed such that its width is less than that of the sealing groove, so that the sealing element is axially movable relative to the seal housing and the static sealing section can be pressed axially against the one or against the other groove side of the sealing groove while forming a seal, depending on the axial pressure differential applied to the sealing element. Among other aspects, this offers the advantage that the sealing element can be arranged in the seal housing with limited all-round mobility, so that it can be optimally aligned to the valve spool without having to be deformed.

The invention is explained in greater detail below with reference to the accompanying drawing, of which:

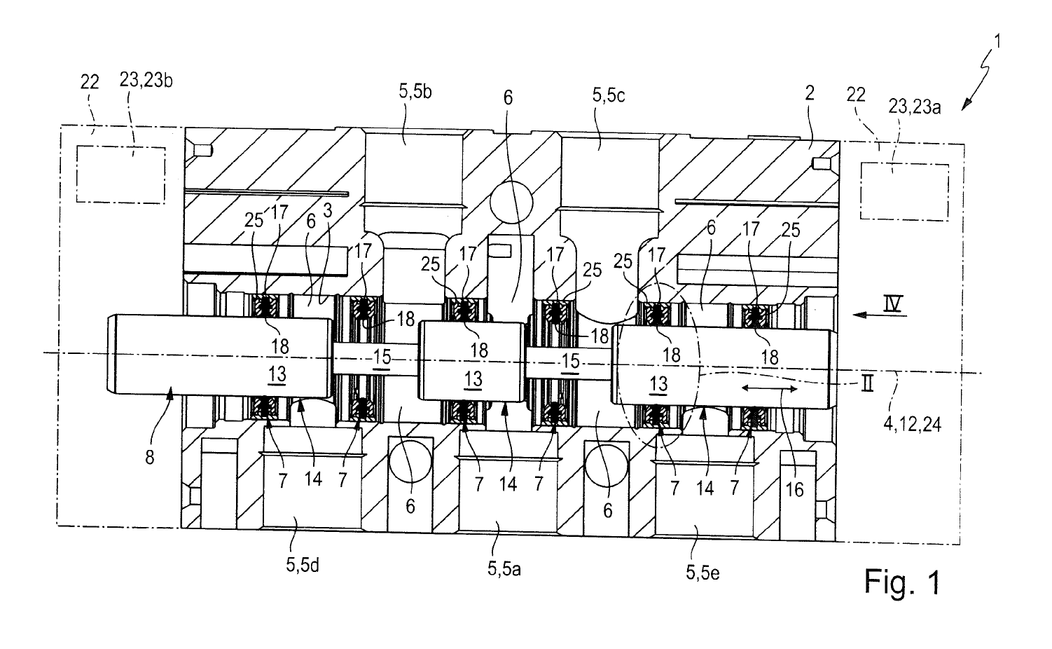

FIG. 1 is a longitudinal section through a preferred embodiment of the valve according to the invention, with terminating bodies at the end faces and drive means for the actuation of the valve being indicated by dot-dash lines,

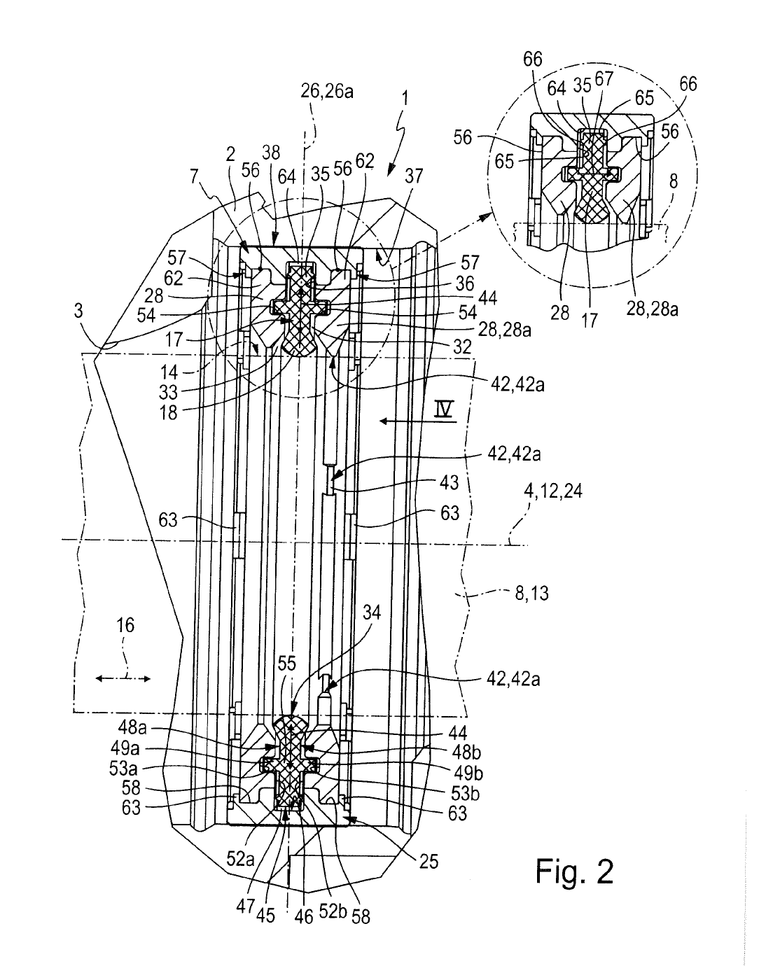

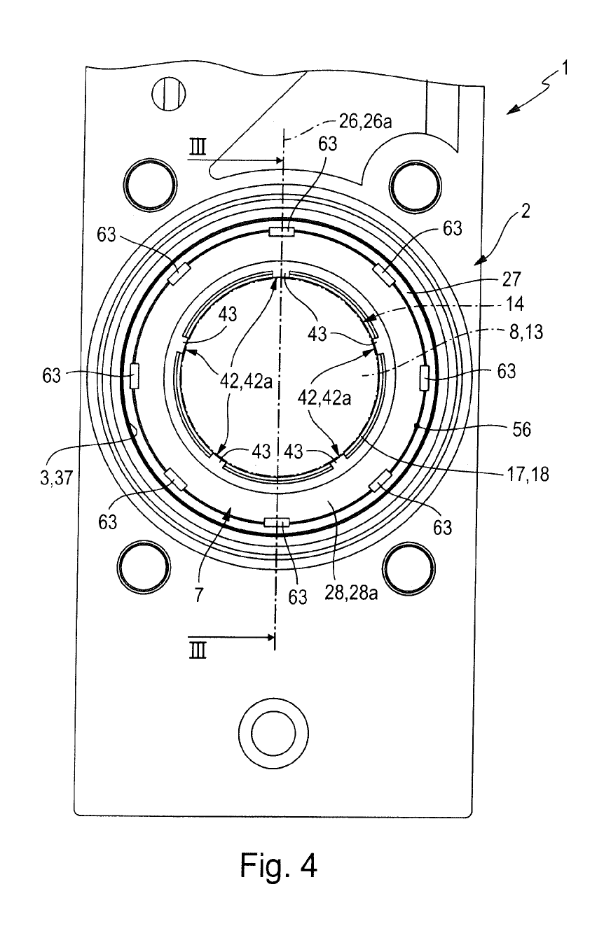

FIG. 2 is an enlarged representation of the region framed by dot-dash lines in FIG. 1, which lies in the region of a seal ring, a section of the seal ring being illustrated separately and the cutting plane of the seal ring extending in accordance with III-III from FIG. 4,

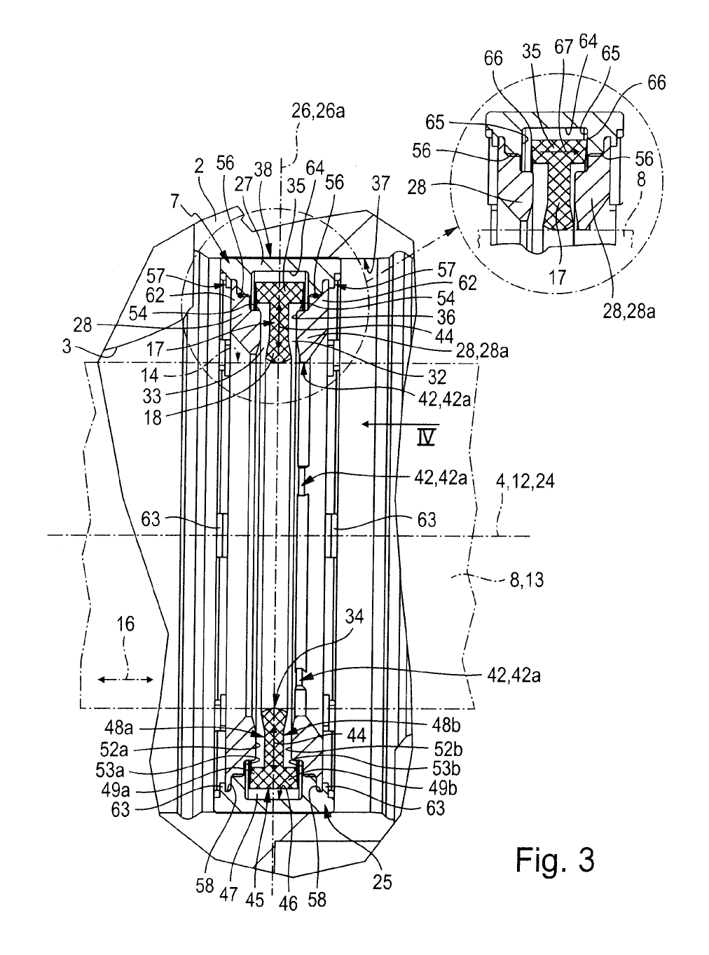

FIG. 3 shows a section of a valve in a representation corresponding to FIG. 2, with an alternative design of a seal ring,

FIG. 4 is an end view of the valve, with an axial view on one of the seal rings in a direction according to arrow IV from FIGS. 1 and 2, the valve spool being indicated by dot-dash lines as in FIGS. 2 and 3,

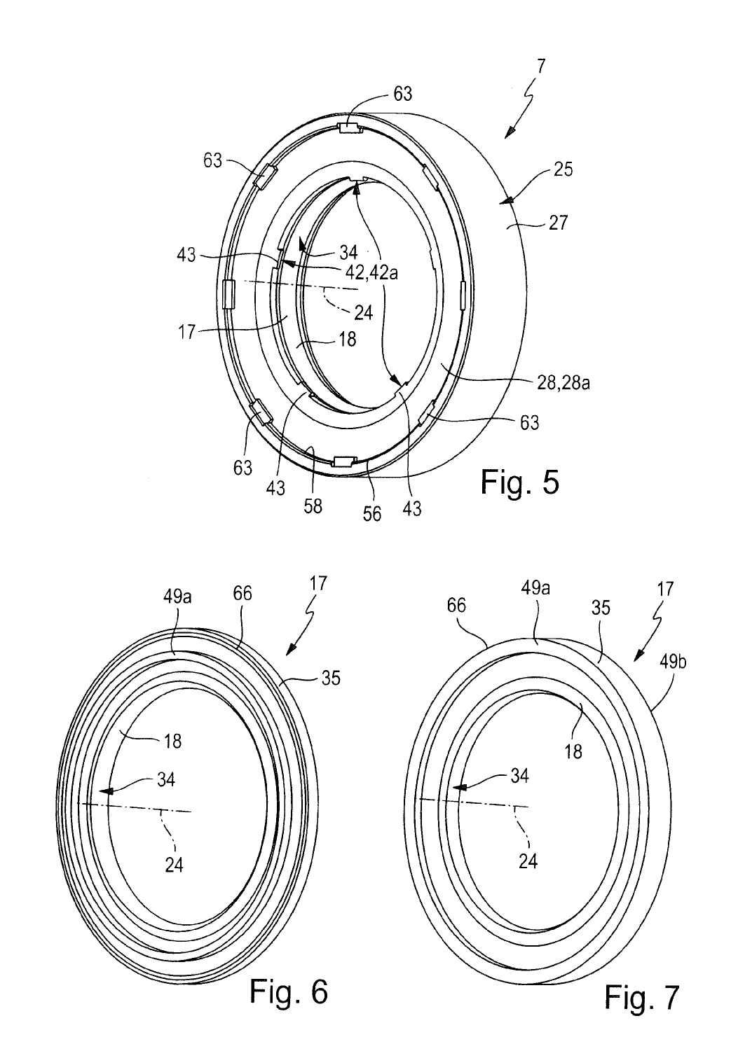

FIG. 5 is an individual perspective representation of a seal ring,

FIG. 6 is a perspective individual representation of the annular sealing element provided in the seal ring according to FIG. 2, and

FIG. 7 is a perspective individual representation of the annular sealing element provided in the seal ring according to FIG. 3.

Unless stated otherwise, the following explanations apply to all embodiments.

The valve identified as a whole by the reference number 1 is preferably constructed as a multiway valve and comprises a valve housing 2, in which a recess 3 having a linear orientation and preferably a cylindrical contour is formed. The recess 3 has an imaginary central longitudinal axis 4, which is indicated by dot-dash lines.

Peripherally into the recess 3, several valve passages 5 passing through the valve housing 2 terminate. Between the recess sections 6 of the recess 3, each of which communicates with one of the valve passages 5, a seal ring 7 of a special structure is placed; this structure will be explained in greater detail below. In any case, several seal rings 7 are preferably placed in the recess 3 with mutual axial spacing.

Each of the two axially outward recess sections 6 is preferably also flanked by a seal ring 7 on its axial outside.

In the recess 3, a valve spool 8 of a piston-type design extends coaxially through the plurality of seal rings 7. Its longitudinal axis 12 coincides with the longitudinal axis 4 of the recess 3.

The valve spool 8 has at least one control section 13 and preferably several control sections 13 arranged at an axial distance from one another, each of which defines a radially oriented outer circumferential surface 14 of the valve spool 8. Between each of the axially adjacent control sections 13, a web section 15 having a smaller cross-section than the control sections 13 extends. By the controlled application of driving forces, the valve spool 8 can be induced to perform a linear switching movement 16 indicated by a double-headed arrow in one or the other axial direction, in order to move it to different working positions relative to the valve housing 2 and the seal rings 7, in which working positions the valve passages 5 are connected to or disconnected from one another in a fluid-tight manner in different patterns.

The result is a fluid connection between two valve passages 5 whenever a web section 15 of the valve spool 8 passes through that seal ring 7 which is located between the recess sections 6 connected to the respective valve passages 5. As the web section 15 has a smaller cross-section than the inner cross-section bounded by the seal ring 7, there is an annular overflow gap available to a fluid for flowing between the valve passages 5.

The connection between two adjacent valve passages 5 is blocked in a fluid-tight manner if, by suitable positioning of the valve spool 8, one of the control sections 13 adopts a position in which it extends through the respective seal ring 7. In this case, the seal ring 7 concentrically bears with an annular sealing element 17 against the outer circumferential surface 14 of the respective control section 17 with all-round sealing contact.

In a switching process, the valve spool 8 slides with its at least one control section 13 along at least one annular sealing element 17, until it has reached the desired working position. As the valve spool 8 can move axially relative to the sealing element 17 which seals it, the section of the annular sealing element 17 which is in sealing contact with the outer circumferential surface 14 can be described as a dynamic sealing section 18.

The valve housing 2 can be provided with a preferably releasable terminating body 22 at one or both of its end faces. Each terminating body 22 bounds the recess 3 at one of its two end faces. The recess 3 can easily extend into the two terminating bodies 22.

The valve 1 is expediently provided with drive means 23 for the controlled application of driving forces to the valve spool 8 for initiating the switching movement 16. These drive means 23 are preferably represented by at least one electrically actuated pilot valve device 23a, 23b, which in particular comprises a solenoid valve or another electrically actuated valve. By means of electric actuation, fluid pressure can be applied to the valve spool 8 in the one and/or the other axial direction for its axial displacement in the recess 3. The drive fluid would be compressed air in particular.

However, the valve 1 may, for example, be designed for direct electric actuation, with drive means 23 of electromechanical, electromagnetic and/or electrodynamic design, so that they apply a driving force based on the respective principle to the valve spool 8.

The valve 1 of the illustrated embodiment is conceived as a 5/2-way valve, having five valve passages 5, which are interconnected in different ways by two different working positions of the valve spool 8. One valve passage 5 is a feed passage 5a, which can be connected to an external pressure source, while two further valve passages 5 are designed as working passages 5b, 5c, which can be connected to a load, and two further valve passages 5 act as relief passages 5d, 5e connected to a pressure sink and in particular to the atmosphere. In each of the two switching positions, the feed passage 5a is connected to a working passage 5b or 5c, which is at the same time disconnected from the relief passages, while the other working passage 5c or 5b is connected to one of the relief passages 5d or 5e while being disconnected from the feed passage 5a.

The design according to the invention can, however, also be used in valves of a different functionality, such as 2/2-way valves or 3/2-way valves. The principle of the invention is further suitable both for on-off valves and for proportional valves.

The number of the seal rings 7 installed into the valve 1 depends on the valve type in particular. A 2/2-way valve, for example, could be equipped with only one seal ring 7.

The seal rings 7 of the valve 1 are identical to one another, so that the detailed description can be applied to any one of the seal rings 7. In the illustrated embodiment, the valve 1 is equipped with seal rings 7 as shown in FIG. 2, but it can be equipped with seal rings 7 as shown in FIG. 3 as an alternative. A mixture of the two types of seal rings 7 can also be used in principle.

The seal ring 7 has a longitudinal axis 24, which coincides with the longitudinal axis 4 of the recess 3 when it is installed into the recess 3.

The seal ring 7 comprises a seal housing 25, which is coaxial with the longitudinal axis 24 and preferably has a rigid structure and an at least substantially U-shaped cross-section. This cross-section is present in a cutting plane defined by the longitudinal axis 24 and a radial axis 26 perpendicular to the former. This cross-section can be seen in FIGS. 1 to 3. The seal housing 25 can, for example, be made of a plastic material or of metal or of a composite material.

The seal ring 7 is arranged such that the U-opening of its cross-section is oriented radially inwards and faces the longitudinal axis 24. Accordingly, the seal housing 25 has an annular base section 27 located radially outside the U-opening and two housing legs 28, which are located opposite one another at a distance in the axial direction of the seal ring 7, and each of which extends around the longitudinal axis 24 while projecting radially inwards from the base section 27. Together, the two housing legs 28 and the base section 27, which connects the two housing legs 28 in the radially outward region, bound an annular space identified as reception chamber 32, which is open radially inwards towards the longitudinal axis 24 with a slot-shaped housing opening 33 defined by the U-opening. The housing opening 33 extends in a ring shape around the longitudinal axis 24.

Each of the two housing legs 28 expediently has the shape of a perforated plate. The annular base section 27 expediently has a sleeve-like structure.

The annular sealing element 17 mentioned above is located in the reception chamber 32 coaxially with the seal housing 25. It is expediently made of a material with rubber-elastic properties, in particular of an elastomer material. This being so, it is elastically and reversibly deformable.

The radially inward annular section of the sealing element 17 forms the dynamic sealing section 18 referred to above. It has a radially inward-oriented sealing surface which shall be referred to as dynamic sealing surface 34 and which bears against the outer circumferential surface 14 of that control section 13 of the valve spool 8 which is currently enclosed by the seal ring 7 in the circumferential direction of the longitudinal axis 12 with all-round sealing contact. If the valve spool 8 performs a switching movement, the outer circumferential surface 14 slides along the dynamic sealing surface 34 until a web section 15 enters the region within the seal ring 7, thereby cancelling any sealing contact between the dynamic sealing section 18 and the valve spool 8.

The annular sealing element 17 has a further sealing section which shall be referred to as static sealing section 35, because it provides a static seal against the seal housing 25 within the reception chamber 32. To provide this static seal, it bears against that inner surface 36 of the seal housing 25 which bounds the reception chamber 32 with a sealing action.

If a control section 13 extends through the seal ring 7, a blocking state is present in which the regions of the recess 3 located on opposite sides of the seal ring 7 are disconnected from one another in a fluid-tight manner. This results from the sealing contact between the dynamic sealing section 18 and the valve spool 8 and from the simultaneous sealing contact between the static sealing section 35 and the seal housing 25. The annular sealing element 17 itself it impermeable to fluids. In addition, the seal housing 25 is secured to the valve housing 2 in a sealed arrangement, so that fluid cannot pass between the seal housing 25 and the valve housing 2. This sealed assembly is preferably obtained by pressing the seal housing 25 into the recess 3, so that pressure is applied radially from the outside by the inner circumferential surface 37 of the recess 3, providing a non-positive hold. This pressure is strong enough for a static sealing contact which prevents a passage of fluid.

If required, additional sealing means can obviously provided between the seal housing 25 and the valve housing 2, or another sealing principle can be implemented as a whole.

A reliable press fit with good sealing action is in particular achieved by providing that the annular base section 27 has a cylindrical outer circumferential surface 38 which, prior to the installation into the recess 3, has a slightly larger cross-section than the recess 3, resulting in a firm press fit when it is pressed into the recess 3, whereby the seal ring 7 is secured in the desired position exclusively by this press fit without any additional retaining means.

One of the two housing legs 28, each of which is annular in shape, is conceived as a guide element providing a transverse support for the valve spool 8 enclosed by it in the radial direction thereof, so that the valve spool 8 is guided for linear movement in the axial direction of its longitudinal axis 12 to perform the switching movements 16. In view of its guiding characteristics, the respective housing leg 28 shall be described as guide leg 28a. The transverse support happens whenever the valve spool 8 extends through the guide leg 28a with the outer circumferential surface 14 of a control section 13.

All seal rings 7 of the valve 1 are expediently designed identical to one another, so that each sealing ring 7 contributes to the transverse support and the linear guidance of the valve spool 8 relative to the valve housing 2. However, it is possible to provide only some of the sealing rings 7 with a guide leg 28a. The arrangement should be configured such that the outer circumferential surface 14 of the valve spool 8 is encompassed by the guide legs 28a of at least two seal rings 7 in each of its axial positions. This ensures a precise alignment of the valve spool 8 relative to the valve housing 2.

The function a guide leg 28a results from the fact that the housing leg 28, 28a in question has at least one and preferably precisely one guide surface 42, which faces radially inwards and extends all around the longitudinal axis 24 of the seal ring 7 and therefore in the circumferential direction all around the valve spool 8 as well. This guide surface 42 is designed such that it can provide the above-mentioned transverse support for the valve spool 8 by direct contact with the outer circumferential surface 14 of the valve spool 8, in particular independently of the associated sealing element 17.

The valve spool 8 is expediently guided relative to the valve housing 2 exclusively by the guide legs 28a of the seal rings 7. There is no need for further guidance means, which are therefore preferably not provided.

The guide surface 42 can be an annular surface which extends continuously around the valve spool 8. It is, however, considered to be more advantageous to use the variant implemented in the illustrated embodiment, in which the guide surface 42 is composed of a plurality of guide surface sections 42a distributed around the valve spool 8 with mutual spacing. Each of these guide surface sections 42a radially facing the valve spool 8 is preferably curved in a circular arc, the radius of curvature preferably being slightly larger than that of the outer circumferential surface 14 of the valve spool 8. Any contact between the guide surface sections 42a and the valve spool 8 is a line contact in particular.

The guide surface sections 42a are expediently represented by guide projections 43, which project radially inwards from edge surfaces facing radially inwards towards the longitudinal axis 14 of the seal ring 7 and which are an integral part of the guide leg 28a and expediently tab-shaped. In the circumferential direction of the guide leg 28a, which is the direction around the longitudinal axis 24, there is between consecutive guide projections 43 in each case a region of the guide leg 29a which is radially offset towards the outside and which can never come into contact with the valve spool 8.

The guide surface sections 42a are expediently distributed evenly around the valve spool 8. Their circumferential dimension in the circumferential direction of the guide leg 28a is expediently smaller than the radially offset regions in between,

The guide surface 42 or the sum of the guide surface sections 42a frames a cross-section through which the valve spool 8 extends and which is matched to the cross-section of the outer circumferential surface 14 of the valve spool 8 in such a way that the latter can easily slide through the guide leg 28a while being radially supported in its position for transverse stability. This is expediently achieved by providing that the cross-sections are matched to one another in the manner of a clearance fit, so that, in an ideally concentric alignment between the valve spool 8 and the guide surface 42, there is a minimal running gap, preferably in the range of a maximum of tenths of a millimetre. This arrangement reliably prevents a jamming of the valve spool 8 in the guide leg 42a.

It is expedient if only one of the two housing legs 28 is designed as a guide leg 28a, while the other housing leg 28 frames a cross-section which is larger than the guide cross-section framed by the guide surface 42, so that this other housing leg 28 never comes into direct contact with the valve spool 8. This avoids static overdetermination, which could otherwise occur, because the two housing legs 28 are axially very close to each other. However, if manufacturing accuracy is adequate, it is possible to design both housing legs 28 as guide legs 28a in the above sense.

In the context of the described guidance function of at least one housing leg 28, in particular, it is advantageous if the annular sealing element 17 is, within the reception chamber 32, capable of floating movement relative to the associated seal housing 25 in a radial plane 26a perpendicular to the longitudinal axis 24 of the seal ring 7. This radial floating capability, which is illustrated in the drawing by a double-headed arrow at 44, preferably applies to the whole sealing element 17 and at least to the dynamic sealing section 18, which comes into direct contact with the outer circumferential surface 14 of the valve spool 8 in the operation of the valve 1.

With this floating, i.e. radially movable, arrangement of the sealing element 17, it is achieved among other factors that the surface pressure between the dynamic seal surface 34 and the valve spool 8 is not increased if the valve spool 8 changes its radial position relative to the seal housing 25 as a result of the minimal running clearance which may exist between the outer circumferential surface 14 and the guide surface 42. As a result, the ease of movement of the valve spool 8 is not affected by any tolerance-related minimal positional changes which may occur in the radial plane 26a.

This effect can be obtained even without a floating mounting of the sealing element 17 if the latter is structured such that it has an adequate internal elastic deformability which can compensate for any transverse movements of the valve spool 8 without increasing the contact force against the outer circumferential surface 14 to a relevant degree.

The seal housing 25 and the annular sealing element 17 are expediently matched in their radial dimensions in such a way that a free annular gap 47, i.e. an air gap, is formed within the reception chamber 32 between the radially outward-oriented outer circumferential surface 45 of the sealing element 17 and the radially inward-oriented inner circumferential surface 46 of the seal housing 25. This free annular gap 47 extends concentrically radially between the sealing element 17 and the seal housing 25. The inner circumferential surface 46 expediently is a section of the inner surface 36 formed radially on the inside of the base section 27. The outer circumferential surface 45 expediently is the outer circumferential surface of the sealing element 17 of the radially outward static sealing section 35.

The height of the free annular gap 47 as measured radially relative to the longitudinal axis 24 is in particular dimensioned such that the above-mentioned radial floating of the sealing element 17 is ensured.

The dimensions of the sealing element 17 as measured radially relative to the longitudinal axis 14 are expediently smaller than the radially measured depth of the reception chamber 32 from the inner circumferential surface 46 to the guide surface 42.

At each of its two axially opposite side surfaces 48a, 48b, the sealing element 17 preferably has an axially protruding securing projection 49a, 49b. Each of these securing projections 49a, 49b is expediently annular and coaxial with the longitudinal axis 24.

In the interior of the reception chamber 32, the seal housing 25 further comprises on each of the two axially facing lateral inner surface sections 52a, 52b an axial securing recess 53a, 53b assigned to the securing projection 49a, 49b located on the same side. These two securing recesses 53a, 53b are likewise annular and coaxial with the longitudinal axis 24.

In this way, the securing projections 49a, 49b and the securing recesses 53a, 53b are arranged in pairs, each securing projection 49a, 49b axially dipping into the associated securing recess 53a, 53b.

In this way, each securing projection 49a, 49b engages from behind in the axial direction a radially outward-oriented securing surface 54 represented by a flank of the associated axial securing recess 53a, 53b.

In an embodiment not shown in the drawing a securing projection and an associated securing recess are provided on only one axial side of the sealing element 17. Also possible is an embodiment in which the mutually engaging securing projections and securing recesses extend only around a part of the longitudinal axis 24.

The cooperating securing projections 49a, 49b and securing recesses 53a, 53b define a securing device which prevents an unintentional radial extraction of the sealing element 17 from the reception chamber 32. Such an extraction could otherwise by caused by a suction generated at the dynamic sealing section 18 in the opening or closing process.

This measure results in a quasi-positive location of the sealing element 17 in the seal housing 25. The radial dimensions of the mutually engaging securing components, i.e. of the securing projection 49a, 49b and securing recess 53a, 53b, are indeed matched in such a way that there is a radial play which does not affect the floating movement according to arrow 44.

The securing projection 49a, 49b can be located in different regions of the sealing element 17. The embodiment of FIG. 2 illustrates a variant in which the securing projection 49a, 49b are arranged at a radial distance from the static sealing sections 35 closer to the longitudinal axis 24. They are in particular located in a transition section 55 of the sealing element 17 which integrates the static sealing section 35 with the dynamic sealing section 18.

In an alternative embodiment, which is illustrated in FIG. 3 by way of example, the securing projection 49a, 49b are directly represented by the static sealing section 35 or are a part thereof. In this case, the axial securing projections 49a, 49b are expediently located radially outside on the sealing element 17 in such a way that they contribute to the formation of the outer circumferential surface 45.

The implementation of the at least one securing projection 49a, 49b as a part of the static sealing section 35 offers the advantage of a particularly simple production of the sealing element 17.

The seal housing 25 preferably has a multi-part structure which simplifies the installation of the sealing element 17. Both housing legs 28 are expediently designed as bodies or components which are separate from the base section 27 and secured thereto by suitable means. The seal housing 25 preferably comprises three separate bodies in the form of the two housing legs 28 and the annular base section 27, which are secured to one another.

Each housing leg 28 is expediently secured to the base section 27 in its own joint region 56 independently of the other housing leg 28. This results in the rigid seal housing 25 with its U-shaped cross-sectional contour.

Both the two housing legs 27 and the base section 27 expediently contribute to the formation of the inner surface 36 of the reception chamber 32.

On each of its two axial outer surfaces 57, the annular base section 27 is preferably provided with a concentrically arranged annular joining groove 58, with which the associated axially fitted annular housing leg 28 engages with its radially outward edge region 62 and in which it is located by means of this radially outward edge region 62. This location of the housing legs 28 is preferably based on local plastic deformation of that region of the base section 27 which bounds the joining groove 58, resulting in radially inward-projecting plastically deformed retaining sections 63, which radially encompass the associated housing leg 28 on the axial outside and clamp it to the base section 27 in the axial direction. This is an effective and easily accomplished securing measure.

The housing legs 28 can be secured to the base section 27 in other ways as well. Each housing leg 28 could, for example, be snap-fitted or latched into the joining groove 58. A welded joint or adhesive bonding would also be possible. This list should not be considered as a final solution.

The static sealing section 35 can expediently cooperate with the inner surface 36 of the seal housing 25 to form a seal in such a way that fluid cannot flow between the two axial sides of the sealing element 17 during the operation of the valve 1 in the blocking state referred to above, even if one and/or another of the joining regions 56 is/are permeable to fluid. This offers the advantage that there is no need for paying special attention to a fluid-tight connection when securing the housing legs 27 to the base section 27, which reduces manufacturing costs. In the illustrated embodiments, the joining region is indeed not fluid-tight.

The special static sealing action preferably results from a sealing groove 64, which is designed as an annular groove with a radially inward-oriented opening and which is formed in the interior of the reception chamber 32 in the radially inward-oriented inner circumferential surface 46 of the annular base section 27 and into which the sealing element 17 dips with its radially outward static sealing section 35. The static sealing section 35 is designed such that it can, while forming a seal, bear against the two sides 65 of the sealing groove 64, which face one another and are arranged opposite one another with axial spacing. As each joining region 56 between the base section 27 and a housing leg 28 is outside the sealing groove 64, the static sealing contact between the static sealing section 35 and at least one groove side 65 provides an effective fluid-tight block which prevents the passage of fluid between the two axial sides of the sealing element 17.

The annular base section 27 is expediently constructed in one piece at least in the region defining the sealing groove 64 and preferably in its totality.

The sealing groove 64 defines the radially outward edge region of the reception chamber 32.

The static sealing action described above is advantageous even if only one of the housing legs 28 is a separate body from the annular base section 27, while the other housing leg 28 is integrated with the annular base section 27. Even in a completely integrated structure of the seal housing 25, the static sealing action described above advantageously prevents a flow around the sealing element 17 in the interior of the reception chamber 32.

An optimum static seal based on especially strong surface pressure can be obtained if at least one raised sealing region 66, which can be pressed against the associated groove side 66, is formed on each of the axially opposite side surfaces of the static sealing section 35. This raised sealing region 66 extends continuously and concentrically around the longitudinal axis of the sealing element 17.

The raised sealing region 66 can, for example, be bead-shaped as in the embodiment shown in FIG. 2 and form a sealing bead which axially projects relative to radially adjacent surface sections of the static sealing section 35. Such a sealing bead expediently has a rounded contour.

Another preferred variant of the raised sealing region 66 is shown in FIG. 3. Here, the raised sealing region 66 has the shape of a sealing edge which is formed in the transition region between the radial outer circumferential surface 45 and each axial side surface of the static sealing section 35 by providing that the axial side surfaces of the static sealing section 35 are inclined relative to the radial plane 26a and diverge radially outwards.

The static sealing section 35 can be designed such that that it always bears against both groove sides 65 of the sealing groove 64 simultaneously while forming a seal. Particularly advantageous, however, is an embodiment in which the static sealing section 35 has a smaller width than the sealing groove 64 and the annular sealing element 17 is accommodated in the seal housing 25 with axial play, therefore being axially movable, so that the static sealing section 35 can alternatively bear against one or the other of the two groove sides 65 of the sealing groove 64 while forming a seal.

Against which of the two groove sides 65 the static sealing section 35 is pressed depends on the fluid pressure conditions axially applied to the sealing element 17. Depending on the pressure differential which acts axially on the sealing element 17, the sealing element 17 is displaced in either the one or the other axial direction within the reception chamber 32 and pressed against the respective groove side 65, being lifted off the other groove side 65.

In the framed sections of the seal ring 7 shown in FIGS. 2 and 3, an operating state is illustrated in which the sealing element 17, owing to a pressure differential acting towards the right, is displaced relative to the seal housing 25 in accordance with arrow 67 and pressed against the groove side 65 oriented against the direction of displacement while forming a static seal.

Owing to the design described above, the sealing element 17 is expediently located in the reception chamber 32 in an arrangement capable of floating axially or of limited movement, which enables it to move together with the valve spool 8 at the start of a switching movement 16 and to come into contact with and be stopped at the groove side 65 placed in front in the direction of movement only when the valve spool 8 already has a certain amount of kinetic energy, so that the release of the slightly adhering contact between the dynamic sealing surface 34 and the outer circumferential surface 14 of the valve spool 8 is facilitated.

If the seal ring 7 is provided with at least one of the axial securing recesses 53a, 53b referred to above, it is advantageous if the static sealing section 35 is shaped such that it simultaneously forms the securing projections 49a, 49b. This applies to the embodiment of FIG. 3. At least one section of the respective securing recess is in this case expediently represented by the sealing groove 64.

According to FIG. 3, each of the two axial securing recesses 53a, 53b consists of two sections, of which one is formed in the base section 27 and the other in the associated housing leg 28. The section of the securing recess 53a, 53b which is formed in the base section 27 simultaneously is a section of the sealing groove 64. Each radial securing surface 64 is here formed on one of the housing legs 28.

The radial depth of the sealing groove 64 is in particular chosen such that the static sealing section 35 can bear against the groove sides 65 with sealing contact irrespective of the radial position currently adopted by the sealing element 17 relative to the seal housing 25. As a result of the preferred radially floating arrangement of the sealing element, the static sealing section 35 is even capable of sliding along the groove side 65 against which it currently bears while maintaining its sealing contact, if the coaxial alignment between the sealing element 17 and the seal housing 25 should change to a minimal degree during a switching movement 16 of the valve spool 8.

1. A valve comprising a valve housing and a piston-type valve spool arranged in a recess of the valve housing in an axially displaceable manner for performing linear switching movements between various working positions, the recess having a central longitudinal axis, and further comprising at least one seal ring, which coaxially encloses the valve spool in the recess and which has an annular seal housing located stationary relative to the valve housing and having a U-shaped cross-section with two opposite housing legs, the seal housing bounding a reception chamber which has, radially on the inside, a slot-like housing opening laterally flanked by the two housing legs and in which an annular sealing element designed on the one hand for acting together with the inner surface of the seal housing to form a static seal and on the other hand for acting together with the outer circumferential surface of the valve spool to form a dynamic seal is coaxially arranged, the sealing element having, for dynamic sealing, a dynamic sealing section located in the region of the housing opening and coaxially enclosing the valve spool with sealing contact in at least one of its working positions, wherein at least one of the housing legs of the seal housing is designed as a guide leg, which has at least one radially inward-oriented guide surface which, by direct contact with the outer circumferential surface of the valve spool, provides a transverse support and a linear guidance of the valve spool independent of the associated sealing element.

2. A valve according to claim 1, wherein only one of the two housing legs of the seal housing is implemented as a guide leg by providing that the cross-section framed by the other housing leg is greater than the cross-section framed by the guide surface of the guide leg.

3. A valve according to claim 1, wherein the guide surface comprises a plurality of guide surface sections distributed at a mutual distance around the valve spool.

4. A valve according to claim 3, wherein the guide surface sections are formed on guide projections (43) which project radially inwards relative to adjacent regions of the guide leg.

5. A valve according to claim 1, wherein at least the dynamic sealing section of the sealing element is capable of floating movement relative to the seal housing in a radial plane extending at right angles to the longitudinal axis of the seal ring.

6. A valve according to claim 1, wherein the sealing element as a whole is capable of floating movement relative to the seal housing in a radial plane extending at right angles to the longitudinal axis of the seal ring.

7. A valve according to claim 1, wherein, between the radially outward-oriented outer circumferential surface of the sealing element and the radially inward-oriented inner circumferential surface of the seal housing, a free annular gap is formed which allows a radial movement of the sealing element relative to the seal housing.

8. A valve according to claim 1, wherein a plurality of seal rings enclosing the valve spool are arranged at an axial distance from one another in the recess of the valve housing.

9. A valve according to claim 1, wherein the sealing element comprises at least one axially protruding securing projection, which engages with an axial securing recess formed laterally on the inner surface of the seal housing, so that the sealing element is secured against a radial extraction from the reception chamber of the seal housing.

10. A valve according to claim 9, wherein the sealing element has on each of its axially opposite side surfaces a securing projection, which engages with one of two opposite axial securing recesses of the inner surface of the seal housing.

11. A valve according to claim 9, wherein the at least one securing projection and the at least one securing recess are designed to be annular.

12. A valve according to claim 1, wherein the seal housing is constructed in several parts and has a radially outward-lying annular base section located between the two housing legs, at least one of the two housing legs being designed as a body which is separate from the base section and secured thereto in a joint region, wherein, in the interior of the reception chamber of the seal housing, a sealing groove which is open towards the radial inside and designed as an annular groove and into which the sealing element dips with its radially outward static sealing section is formed in the radially inward-oriented inner circumferential surface of the base section, this static sealing section being designed to act together axially with the two groove sides of the sealing groove located opposite each other in the base section to provide a static seal.

13. A valve according to claim 12, wherein each housing leg is designed as a body which is separate from the base section and secured thereto in an own joint region, the sealing groove being located between the two joint regions.

14. A valve according to claim 12, wherein the seal ring is provided on the axially opposite side surfaces of its static sealing section with at least one raised sealing region, which is designed as a sealing edge or a sealing bead and which is able to bear against the adjacent groove side of the sealing groove while forming a static seal.

15. A valve according to claim 12, wherein the static sealing section has a width which is less than that of the sealing groove, wherein the annular sealing element is axially movable in the seal housing, so that it is able to be sealingly pressed axially against one of the groove sides of the sealing groove by the axial pressure differential applied in operation.

16. A valve according to claim 4, wherein the guide projections are designed to be tab-like.
